(19) United States
(12) Patent Application Publication
(10) Pub. No.: US 2024/0235950 A9
(43) Pub. Date: Jul. 11, 2024

(54) INFRASTRUCTURE DESIGN SYSTEM AND INFRASTRUCTURE DESIGN METHOD

(71) Applicant: Hitachi, Ltd., Tokyo (JP)

(72) Inventors: Daisuke MASHIMO, Tokyo (JP); Masayuki TAKASE, Tokyo (JP)

(73) Assignee: Hitachi, Ltd., Tokyo (JP)

(21) Appl. No.: 18/489,314

(22) Filed: Oct. 18, 2023

(30) Foreign Application Priority Data
Oct. 21, 2022 (JP) 2022-169508

(51) Int. Cl. H04L 41/14; H04L 43/0852

(52) U.S. Cl. CPC H04L 41/145; H04L 43/0852

(57) ABSTRACT

An infrastructure design system includes an infrastructure design apparatus configured to generate infrastructure design information including information regarding a server infrastructure in which an application of a solution service is installed and a wireless communication infrastructure that connects the server infrastructure with a place where the solution service is used. The infrastructure design apparatus manages provision cost information regarding each of the wireless communication infrastructure and the server infrastructure, calculates estimated latency at a time of providing the solution service, on the basis of a communication delay between a solution service usage environment and the server infrastructure and a processing delay of the application, selects a combination of the wireless communication infrastructure and the server infrastructure on the basis of the estimated latency and a provision cost, and outputs the combination as infrastructure design information.

### BACKGROUND OF THE INVENTION

### 1. Field of the Invention

The present invention pertains to an infrastructure design system and an infrastructure design method.

### 2. Description of the Related Art

With the introduction of fifth-generation (5G) mobile communication, such wireless communication that has low latency, is broadband, and is highly reliable has been available. As a result, it becomes possible to integrate various existing networks at sites where operation technology (OT) work is carried out, to thereby provide digital transformation (DX) solution services aimed at streamlining business, which has been difficult with the conventional wireless communication, while reducing costs for network construction and operation. In particular, in a manufacturing industry or logistics industry where there is a labor shortage or customer needs are diversified, for example, there is a desire to streamline business by introducing new solutions such as real-time work instructions using high-definition video analysis, device control that enables persons and robots to work collaboratively, and remote control that gives an operator a sense of actually being there.

In order to provide such solution services as described above, it is necessary to select, according to performance requirements for each solution service and a usage scale thereof, ones from among computational infrastructures such as edge servers (multi-access edge computing (MEC)) or cloud servers for executing an application and communication infrastructures such as local/public 5G, long-term evolution (LTE), and Wi-Fi for connecting the computational infrastructure with a site where the solution service is used, such that a provision cost, e.g., a construction cost, becomes optimal, and perform infrastructure design.

An example of the performance requirements for a solution service is latency. To provide a solution service, it is necessary to perform infrastructure design while taking into account provision costs regarding various combinations of computational infrastructures and communication infrastructures that can satisfy a latency requirement for the solution service.

It is conceivable that, if a system engineer performs such infrastructure design manually, for example, a lead time required to provide a service may be lengthened, and it may take time to redesign the infrastructure in a case where the scale of the service used by a customer has changed, increasing costs of the solution provision. For these reasons, it is necessary to provide an infrastructure design system capable of, while taking provision costs into account, promptly and easily designing such communication and computational infrastructures that can satisfy a latency requirement for a solution.

JP-2020-140276-A (hereinafter, referred to as Patent Document 1) discloses a method of creating network setting contents for a control apparatus that constructs a network by using a network requirement generated through an analysis of a service requirement inputted by a user. JP-2020-184745-A (hereinafter, referred to as Patent Document 2) discloses a method in which a resource orchestrator allocates, while minimizing data center migration and satisfying a guaranteed delay level, communication and computational resources to a mobile user who is moving along a predicted route.

### SUMMARY OF THE INVENTION

According to the method disclosed in Patent Document 1, network design information is generated on the basis of the service requirement. However, the details of selection of a connection destination server to which an application is to be deployed, and allocation of computational resources are not given in Patent Document 1. In contrast, according to the method disclosed in Patent Document 2, for a site where the solution is used, a server to which an application is to be deployed can be selected from among a plurality of servers while a delay limit is taken into account.

In the related art, however, it has been considered that infrastructure design information regarding a communication infrastructure and a computational infrastructure cannot be provided by appropriately taking the latency and the provision cost into account.

A typical example of the invention disclosed in the present application is as follows. That is, there is provided an infrastructure design system that includes an infrastructure design apparatus configured to generate infrastructure design information including information regarding a server infrastructure in which an application of a solution service is installed and a wireless communication infrastructure that connects the server infrastructure with a place where the solution service is used. The infrastructure design apparatus includes a processor and a storage unit. The storage unit manages provision cost information regarding each of the wireless communication infrastructure and the server infrastructure. The processor calculates estimated latency at a time of providing the solution service, on the basis of a communication delay between the place where the solution service is used and the server infrastructure and a processing delay of the application, selects a combination of the wireless communication infrastructure and the server infrastructure on the basis of the estimated latency and a provision cost managed by the storage unit, and outputs the combination as infrastructure design information. Note that the infrastructure design apparatus may be an infrastructure design server and that the infrastructure design server may output infrastructure design information to a terminal of the infrastructure design server via a communication interface.

A typical example of the invention disclosed in the present application is as follows. That is, there is provided an infrastructure design method of generating, by an infrastructure design apparatus including a processor and a storage unit, infrastructure design information including information regarding a server infrastructure in which an application of a solution service is installed and a wireless communication infrastructure that connects the server infrastructure with a place where the solution service is used. The method includes managing, by the storage unit, provision cost information regarding each of the wireless communication infrastructure and the server infrastructure, calculating, by the processor, estimated latency at a time of providing the solution service, on the basis of a communication delay between the place where the solution service is used and the server infrastructure and a processing delay of the application, and selecting, by the processor, a combination of the wireless communication infrastructure and the server infrastructure on the basis of the estimated latency and a provision cost and outputting the combination as infrastructure design information.

According to the present invention, the infrastructure design information regarding the communication infrastructure and the computational infrastructure can be provided by appropriately taking the latency and the provision cost into account. Note that the abovementioned problem, configuration, and effect will be clarified by the description of the following embodiments.

### BRIEF DESCRIPTION OF THE DRAWINGS

FIG. 1 is a block diagram illustrating an example of an infrastructure configuration designed by an infrastructure design system according to a first embodiment;

FIG. 2 is a block view illustrating an example of a functional configuration of an infrastructure design server according to the first embodiment;

FIG. 3 is a block view illustrating an example of a hardware configuration of the infrastructure design server;

FIG. 4 is an explanatory view illustrating an example of a service template table;

FIG. 5 is an explanatory view illustrating an example of a wireless communication infrastructure information table;

FIG. 6 is an explanatory view illustrating an example of a server infrastructure information table;

FIG. 7 is an explanatory view illustrating an example of an inter-area delay information table;

FIG. 8 is a sequence diagram illustrating an example of an operation of performing infrastructure design by the infrastructure design server;

FIG. 9 is a flow chart illustrating an example of an operation of generating service requirement information by a service requirement generation unit of the infrastructure design server;

FIG. 10 is a flow chart illustrating an example of an operation of generating infrastructure design information by an infrastructure design unit of the infrastructure design server;

FIG. 11 is a flow chart illustrating an example of an operation of calculating an estimated value of latency by the infrastructure design unit of the infrastructure design server;

FIG. 12 is an explanatory view illustrating an example of a display of a service provision information input screen generated by an operator input/output unit of the infrastructure design server;

FIG. 13 is an explanatory view illustrating an example of a display of an infrastructure design information output screen generated by the operator input/output unit of the infrastructure design server;

FIG. 14 is a block view illustrating an example of a functional configuration of an infrastructure design server according to a second embodiment;

FIG. 15 is an explanatory view illustrating an example of a service provision information table;

FIG. 16 is an explanatory view illustrating an example of a server infrastructure information table;

FIG. 17 is a sequence diagram illustrating an example of an operation of performing the infrastructure design again by the infrastructure design server when the number of service-provided users has changed;

FIG. 18 is a flow chart illustrating an example of an operation of generating infrastructure design information by an infrastructure design unit of the infrastructure design server when the number of service-provided users has changed;

FIG. 19 is a sequence diagram illustrating an example of an operation of performing the infrastructure design again by the infrastructure design server in a case where latency is exceeding a latency limit; and

FIG. 20 is a flow chart illustrating an example of an operation of generating the infrastructure design information by the infrastructure design unit of the infrastructure design server when the latency is exceeding the latency limit.

### DESCRIPTION OF THE PREFERRED EMBODIMENTS

Embodiments will be described below with reference to the drawings. The embodiments are examples for explaining the present invention, and omissions and simplifications are made thereon as appropriate in order to clarify the explanation. The present invention can also be implemented in various other forms. Unless otherwise specified, each component may be a single component or multiple components.

Positions, sizes, shapes, ranges, etc., of the components illustrated in the drawings may be different from actual positions, sizes, shapes, ranges, etc., in order to facilitate understanding of the invention. Accordingly, the present invention is not necessarily limited to the positions, sizes, shapes, ranges, etc., disclosed in the drawings.

In the following description, various items of information are expressed as a “table,” a “list,” a “queue,” etc., but may also be expressed as any other data structure. For example, various items of information expressed as an “XX table,” an “XX list,” an “XX queue,” etc., may also be expressed as “XX information.” While “identification information,” an “identifier,” a “name,” an “ID,” a “number,” etc., are used in the following description to explain identification information, these terms can mutually be interchanged.

In a case where a plurality of components have the same or similar function, they are denoted by the same reference sign with different suffixes added thereto. However, if they do not need to be distinguished from each other, they are denoted by the same reference sign without suffixes.

In the following description of the embodiments, processing is performed by a program being executed, in some cases. In such a case, a calculator uses a processor (for example, a central processing unit (CPU) or a graphics processing unit (GPU)) to execute a program and performs processing defined in the program, with the use of a storage resource (for example, a memory) or an interface device (for example, a communication port), for example. Accordingly, a subject which performs processing by executing a program may be the processor. Similarly, the subject which performs the processing by executing the program may be a controller, an apparatus, a system, a calculator, or a node having a processor. The subject which performs the processing by executing the program is only required to be a computing unit, and may include a dedicated circuit that performs specific processing. Here, the dedicated circuit is, for example, a field-programmable gate array (FPGA), an application-specific integrated circuit (ASIC), or a complex programmable logic device (CPLD).

A program may be installed in a calculator from a program source. The program source may be a program distribution server or a storage media that can be read by a calculator, for example. In a case where the program source is the program distribution server, the program distribution server may include a processor and a storage resource that stores a program to be distributed, and the processor of the program distribution server may distribute, to another calculator, the program to be distributed. In addition, in the embodiments, two or more programs may be provided as one program, and one program may be provided as two or more programs.

In the embodiments, a technique for designing, while taking latency into account, a computational infrastructure and communication for a system required to provide a solution service will be described. This technique can contribute to the service provision from an economic perspective. Here, the latency is broadly divided into two types of delay: a communication delay between a site where a solution service is used and a server on which an application operates; and a processing delay of the application that operates on the server. The communication delay is determined by, for example, a type of communication infrastructure to be used or a communication distance, and the processing delay is determined by, for example, computational resources such as the number of CPU cores or a memory that is allocated to the application on the server.

### First Embodiment

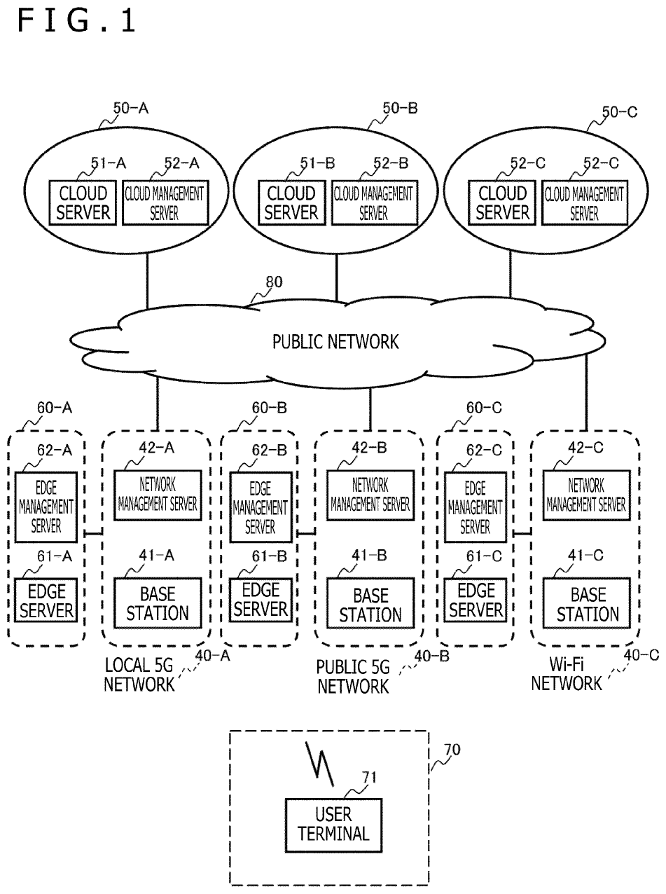

With reference to FIG. 1 through FIG. 13, an infrastructure design system according to a first embodiment will be described below.

FIG. 1 is a block diagram illustrating an example of an infrastructure configuration pattern that is for providing solution services and that is designed by an infrastructure design server 1 of the infrastructure design system according to the present embodiment. The infrastructure design server 1 determines, as an infrastructure for allowing a user to use a solution service, a combination of a wireless communication infrastructure and a server infrastructure 50 (reference signs 50-A through 50-C in FIG. 1) or a server infrastructure 60 (reference signs 60-A through 60-C in FIG. 1), and generates design information.

A wireless communication infrastructure 40 (reference signs 40-A through 40-C in FIG. 1) is a network infrastructure for connecting a user terminal 71 of a user, which is present in a solution service usage environment 70, to the server infrastructure 50 or the server infrastructure 60 via a wireless interface. Examples of the wireless communication infrastructure 40 include a local 5G network, a public 5G network, and a Wi-Fi network. The wireless communication infrastructure 40 has a base station 41 (reference signs 41-A through 41-C in FIG. 1) that implements an access point function according to an employed wireless method, and a network management server 42 (reference signs 42-A through 42-C in FIG. 1) for setting the network and performing user management.

The server infrastructure 50 is provided on a cloud and is connected to the user terminal 71 via the wireless communication infrastructure 40 and a public network 80. The server infrastructures 50-A, 50-B, and 50-C represent different clouds. The respective clouds may be present in physically different areas, and the physical distance to the solution service usage environment 70 may possibly be different among the clouds. In addition, the server infrastructure 50 includes a cloud server 51 (reference signs 51-A through 51-C in FIG. 1) that provides computational resources for executing a solution service application, and a cloud management server 52 (reference signs 52-A through 52-C in FIG. 1) for setting the cloud server 51 and monitoring a usage situation thereof. The cloud management server 52 monitors communication between the cloud server 51 and the user terminal 71 and enables measurement of a communication delay for each solution service and measurement of a processing delay of a solution service application executed on the cloud server 51.

Meanwhile, the server infrastructure 60 is provided on an edge cloud that is directly connected to the wireless communication infrastructure 40. The server infrastructure 60 includes an edge server 61 (reference signs 61-A through 61-C in FIG. 1) that provides computational resources for executing a solution service application, and an edge management server 62 (reference signs 62-A through 62-C in FIG. 1) for setting the edge server 61 and monitoring a usage situation thereof. The edge management server 62 monitors communication between the edge server 61 and the user terminal 71 and enables measurement of a communication delay for each solution service and measurement of a processing delay of a solution service application executed on the edge server 61.

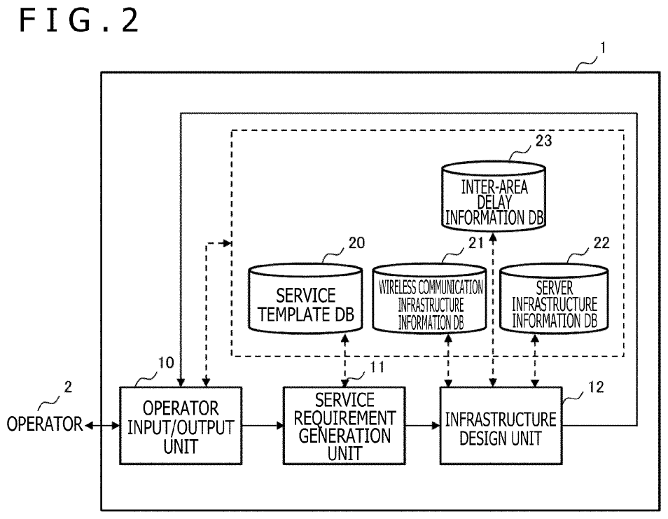

Next, with reference to FIG. 2, an example of a functional configuration of the infrastructure design server 1 will be described. FIG. 2 is a block view illustrating an example of the functional configuration of the infrastructure design server 1 according to the present embodiment. The infrastructure design server 1 includes an operator input/output unit 10, a service requirement generation unit 11, an infrastructure design unit 12, a service template database (DB) 20, a wireless communication infrastructure information DB 21, a server infrastructure information DB 22, and an inter-area delay information DB 23.

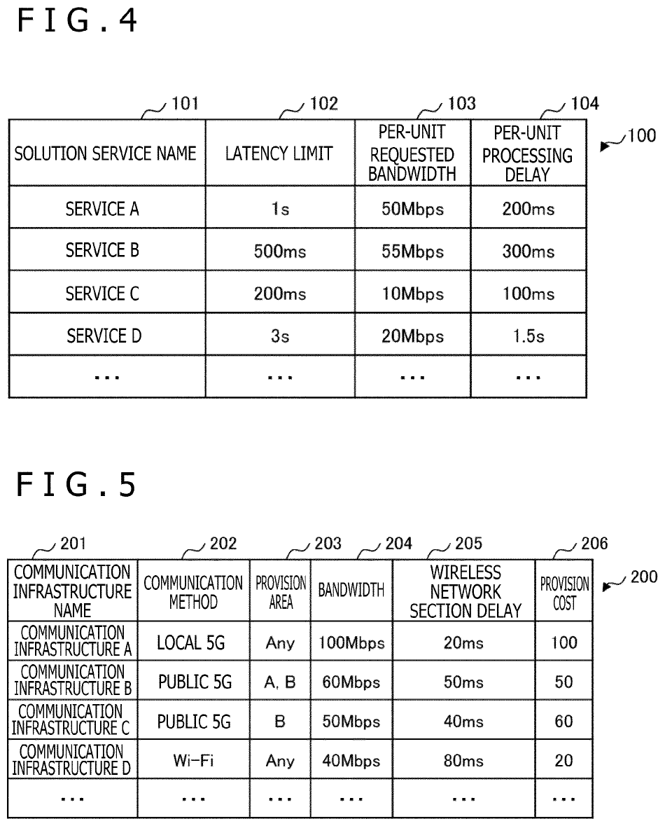

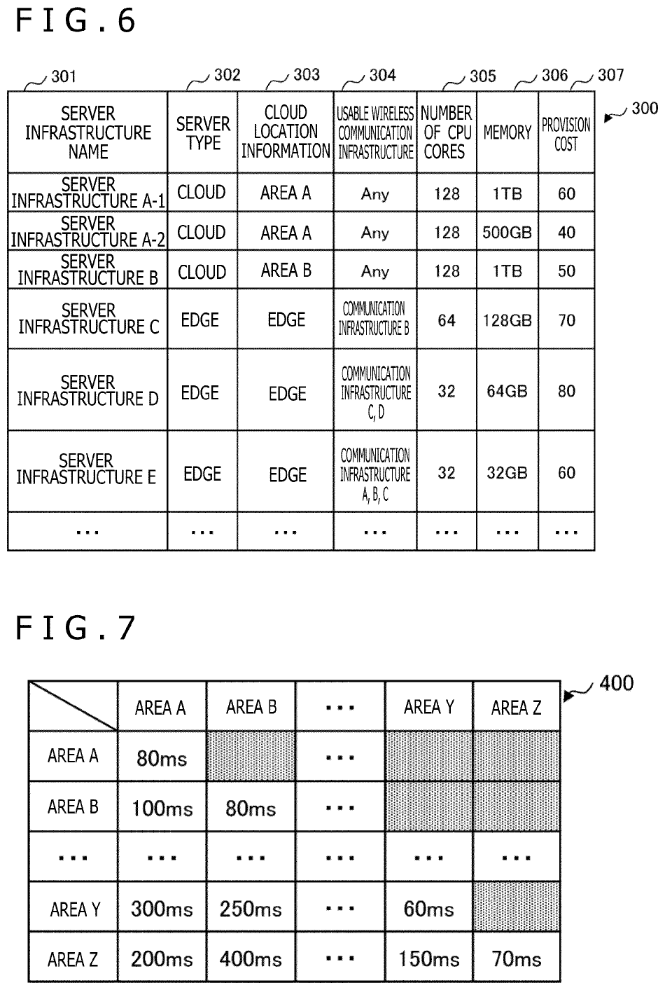

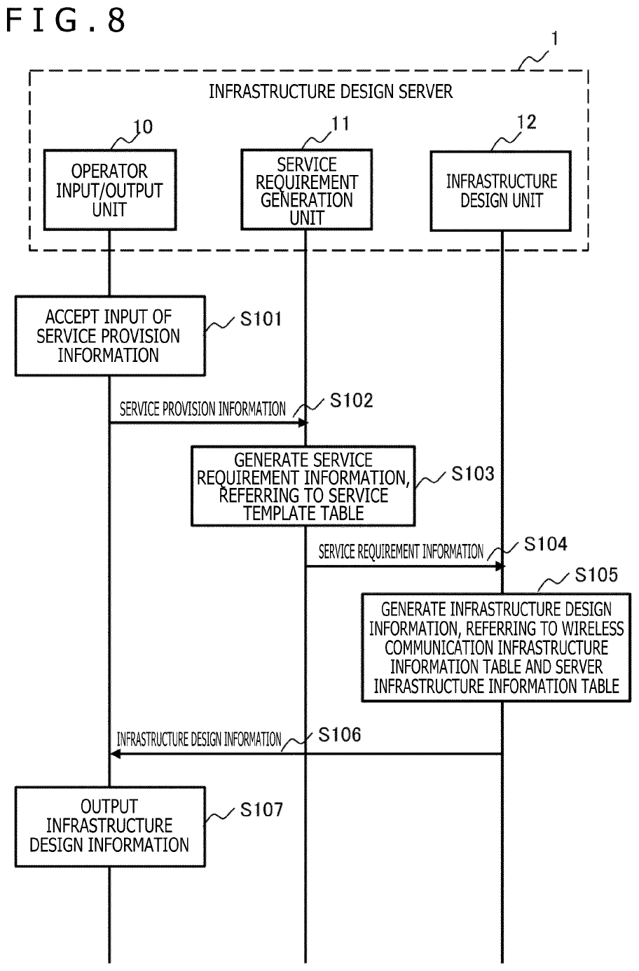

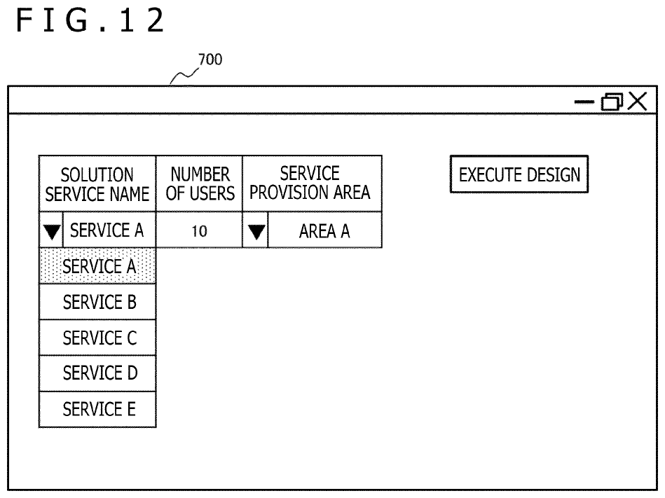

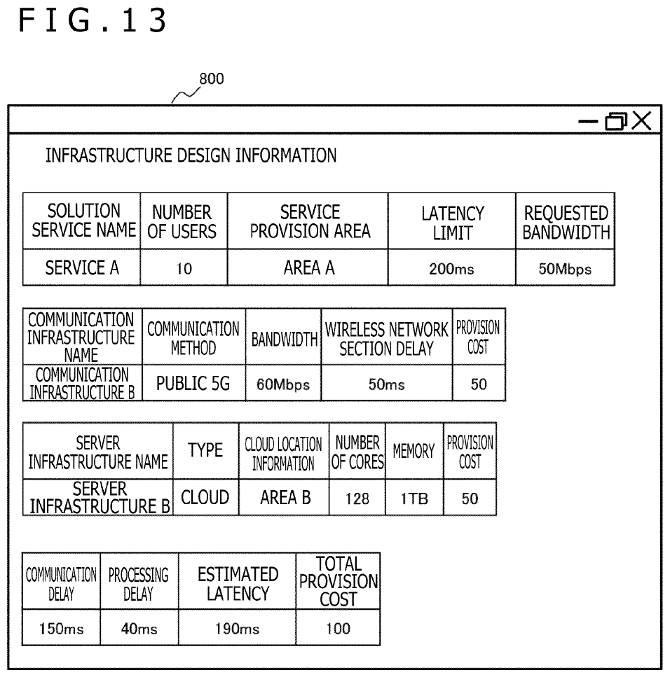

The operator input/output unit 10 generates a service provision information input screen 700 (described later in FIG. 12) for allowing an operator 2 to input service provision information, receives input of the service provision information, and outputs the service provision information to the service requirement generation unit 11. The service provision information includes, for example, a solution service name of a service to be provided, the number of users using the service, and a service provision area in which the service is provided. The operator input/output unit 10 also generates an infrastructure design information output screen 800 (described later in FIG. 13) for outputting infrastructure design information generated by the infrastructure design unit 12, and outputs the infrastructure design information output screen 800 to the operator 2. Further, the operator input/output unit 10 outputs, to the operator 2, a service template table 100 that is managed by the service template DB 20, a wireless communication infrastructure information table 200 that is managed by the wireless communication infrastructure information DB 21, a server infrastructure information table 300 that is managed by the server infrastructure information DB 22, and an inter-area delay information table 400 that is managed by the inter-area delay information DB 23. In addition, the operator input/output unit 10 receives, from the operator 2, information for registering, correcting, or deleting an entry in each table, and executes registration, correction, or deletion of the entry in each table. Note that the details of the service template table 100, the wireless communication infrastructure information table 200, the server infrastructure information table 300, and the inter-area delay information table 400 will be described later by using FIG. 4, FIG. 5, FIG. 6, and FIG. 7.

When receiving the service provision information from the operator input/output unit 10, the service requirement generation unit 11 generates service requirement information by referring to the service template table 100 managed by the service template DB 20, and outputs the service requirement information to the infrastructure design unit 12. The details of the service requirement information will be described later.

When receiving the service requirement information from the service requirement generation unit 11, the infrastructure design unit 12 generates infrastructure design information on the basis of the service requirement information by referring to the wireless communication infrastructure information table 200 managed by the wireless communication infrastructure information DB 21, the server infrastructure information table 300 managed by the server infrastructure information DB 22, and the inter-area delay information table 400 managed by the inter-area delay information DB 23, and outputs the infrastructure design information to the operator input/output unit 10.

The service template DB 20 is a database that manages the service template table 100.

The wireless communication infrastructure information DB 21 is a database that manages the wireless communication infrastructure information table 200.

The server infrastructure information DB 22 is a database that manages the server infrastructure information table 300.

The inter-area delay information DB 23 is a database that manages the inter-area delay information table 400.

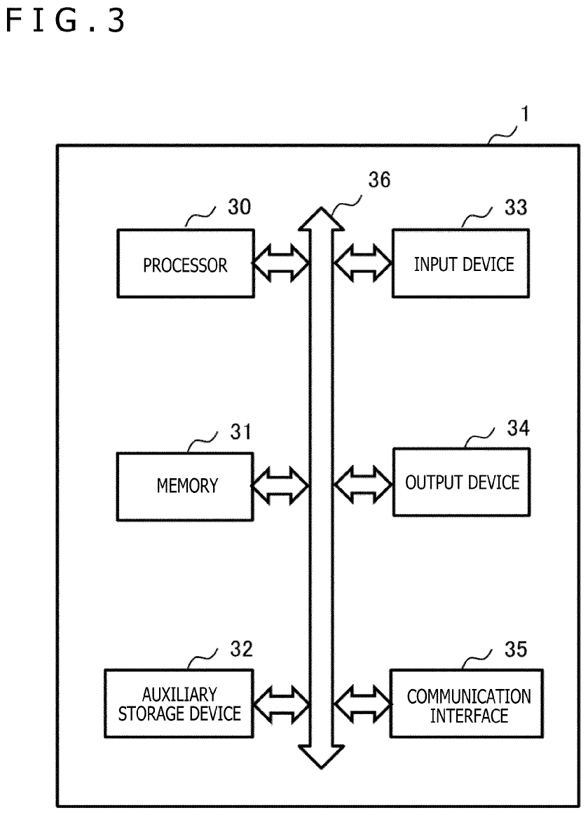

Next, with reference to FIG. 3, an example of a hardware configuration of the infrastructure design server 1 will be described. FIG. 3 is a block view illustrating an example of the hardware configuration of the infrastructure design server 1. The infrastructure design server 1 according to the present embodiment is configured by a calculator that has a processor 30, a memory 31, an auxiliary storage device 32, an input device 33, an output device 34, a communication interface 35, and a bus 36.

The processor 30 is an arithmetic device that executes a program stored in the memory 31. The processor 30 executes various programs to thereby execute functions of the respective units (for example, the operator input/output unit 10, the service requirement generation unit 11, the infrastructure design unit 12, etc.) of the infrastructure design server 1. Note that part of the processing performed by the processor 30 executing a program may be executed by other hardware, i.e., another arithmetic device, such as an ASIC or an FPGA.

The memory 31 includes a read-only memory (ROM), which is a non-volatile storage element, and a random-access memory (RAM), which is a volatile storage element. The ROM stores a program or the like (for example, a basic input/output system (BIOS)) that does not change. The RAM is a high-speed volatile storage element such as a dynamic random-access memory (DRAM), and temporarily stores a program executed by the processor 30 and data used when the program is executed.

The auxiliary storage device 32 (a storage unit) is a large-capacity non-volatile storage device such as a magnetic storage device (a hard disk drive (HDD)) or a flash memory (a solid-state drive (SSD)), for example. In addition, the auxiliary storage device 32 stores data (for example, the service template table 100, the wireless communication infrastructure information table 200, etc.) used when the processor 30 executes a program, and a program that is executed by the processor 30. In other words, each of the functions of the infrastructure design server 1 is implemented when a program is read out from the auxiliary storage device 32, loaded into the memory 31, and executed by the processor 30.

The input device 33 is an input device such as a keyboard or a mouse. The output device 34 is an interface which is connected to an output device such as a display or a printer is connected and which outputs a result of executing a program in a format that an operator can visually recognize. Note that an operator terminal connected to the infrastructure design server 1 via a network may serve as an input device and an output device. In this case, the infrastructure design server 1 may have a web server function, and the operator terminal may access the infrastructure design server 1 according to a predetermined protocol (for example, http).

The communication interface 35 is a network interface device that controls communication with another apparatus (for example, a terminal of the infrastructure design server 1) according to a predetermined protocol.

The bus 36 is a communication channel for transmitting and receiving data to and from each piece of hardware.

Next, with reference to FIG. 4, an example of a service template table will be described. FIG. 4 illustrates an example of the service template table 100 managed by the service template DB 20. The service template table 100 according to the present embodiment includes a solution service name 101, a latency limit 102, a per-unit requested bandwidth 103, and a per-unit processing delay 104. The solution service name 101 is a service name for uniquely identifying a solution service, and differs among entries in the service template table 100. The latency limit 102 is maximum latency that is acceptable at a time of providing the solution service. The latency in the present embodiment is defined as the sum of a communication delay from the user terminal 71 to the cloud server 51 or the edge server 61 and a processing delay of an application executed by the cloud server 51 or the edge server 61. Alternatively, the latency may be defined as the sum of a round-trip communication delay from the user terminal 71 to the cloud server 51 or the edge server 61 and a processing delay. The per-unit requested bandwidth 103 is a communication bandwidth of the wireless communication infrastructure 40 which is necessary for the number of users per unit who use the solution service, and is a value that enables calculation of a necessary communication bandwidth according to the number of users to whom the service is provided. The per-unit processing delay 104 is a processing delay in a case where the application is executed with an amount of computational resources per unit which are to be provided, with respect to the number of users per unit who use the solution service, and is a value that enables calculation of a processing delay according to the number of users to whom the service is provided and an amount of computational resources for executing the application.

Next, with reference to FIG. 5, an example of a wireless communication infrastructure information table will be described. FIG. 5 is an example of the wireless communication infrastructure information table 200 managed by the wireless communication infrastructure information DB 21. The wireless communication infrastructure information table 200 according to the present embodiment includes a communication infrastructure name 201, a communication method 202, a provision area 203, a bandwidth 204, a wireless network section delay 205, and a provision cost 206. The communication infrastructure name 201 is a name for uniquely identifying a wireless communication infrastructure that is to be provided, and differs among entries in the wireless communication infrastructure information table 200. The communication method 202 indicates a communication method used by a wireless communication infrastructure of a corresponding entry, and includes information such as local 5G, public 5G, or Wi-Fi, for example. The provision area 203 includes information regarding an area where the communication infrastructure of the corresponding entry can be provided. The bandwidth 204 indicates a maximum communication bandwidth that the wireless communication infrastructure of the corresponding entry can provide. The wireless network section delay 205 indicates a maximum communication delay in a network section provided by the wireless communication infrastructure of the corresponding entry. The provision cost 206 indicates a provision cost at a time of providing the wireless communication infrastructure of the corresponding entry. The provision cost 206 is, for example, a fee for providing the corresponding wireless communication infrastructure. In another example, the provision cost 206 is an amount of carbon dioxide emitted in a case of using the corresponding wireless communication infrastructure. For example, the provision cost 206 may be set to a value based on the communication method 202, the bandwidth 204, the wireless network section delay 205, and the like.

Next, with reference to FIG. 6, an example of a server infrastructure information table will be described. FIG. 6 is an example of the server infrastructure information table 300 managed by the server infrastructure information DB 22. The server infrastructure information table 300 according to the present embodiment includes a server infrastructure name 301, a server type 302, cloud location information 303, a usable wireless communication infrastructure 304, the number of CPU cores 305, a memory 306, and a provision cost 307. The server infrastructure name 301 is a name for uniquely identifying a server infrastructure that is to be provided, and differs among entries in the server infrastructure information table 300. The server type 302 is information regarding whether a server infrastructure of a corresponding entry is provided on a cloud or an edge cloud. The cloud location information 303 indicates information regarding a location where the server infrastructure of the corresponding entry is present. In a case where the server type 302 of the server infrastructure is “cloud,” the cloud location information 303 includes information regarding an area representing a classification of a location where the server infrastructure is present. In a case where the server type 302 is “edge,” the cloud location information 303 includes information indicating that the server infrastructure is present on an edge cloud. The usable wireless communication infrastructure 304 indicates a wireless communication infrastructure name 201 of a wireless communication infrastructure that can be selected as being used in combination with the server infrastructure of the corresponding entry. For example, in a case of a server infrastructure provided on an edge cloud owned by a communication provider that provides a wireless communication infrastructure, the usable wireless communication infrastructure may be limited to the wireless communication infrastructure provided by the communication provider. The number of CPU cores 305 indicates information regarding the number of CPU cores that are provided as a computational resource by the server infrastructure of the corresponding entry. The memory 306 indicates information regarding a size of memory that is provided as a computational resource by the server infrastructure of the corresponding entry. The provision cost 307 is a provision cost at a time of providing the corresponding server infrastructure, and indicates information similar to the provision cost in the wireless communication infrastructure information table 200. In other words, the provision cost 307 is a fee, for example, or is an amount of emitted carbon dioxide in another example. In addition, the provision cost 307 may be set to a value based on the number of CPU cores 305 and the memory 306, for example.

Next, with reference to FIG. 7, an example of an inter-area delay information table will be described. FIG. 7 is an example of the inter-area delay information table 400 managed by the inter-area delay information DB 23. The inter-area delay information table 400 includes information regarding a communication delay in a section of the public network 80 in a case of performing communication between an area in which the solution service usage environment 70 is present and an area in which the server infrastructure 50 provided on a cloud is present.

Next, with reference to FIG. 8, an example of an operation performed by the infrastructure design server. FIG. 8 is a sequence diagram illustrating an example of an operation of performing infrastructure design by the infrastructure design server 1 according to the present embodiment.

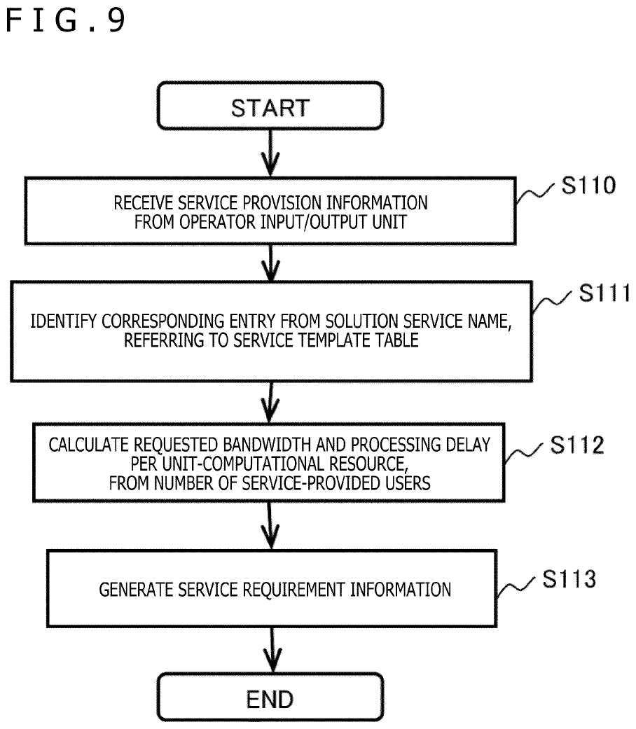

First, the operator input/output unit 10 displays a service input screen to the operator 2, receives input of service provision information (S101), and outputs the service provision information to the service requirement generation unit 11 (S102). The service provision information includes information regarding a solution service name, the number of service-provided users, and a service provision area. The service requirement generation unit 11 refers to the service template table 100 on the basis of the service provision information received from the operator input/output unit 10, generates service requirement information (S103), and outputs the service requirement information to the infrastructure design unit 12 (S104). The details of the processing for generating the service requirement information (S103) will be described later by using FIG. 9.

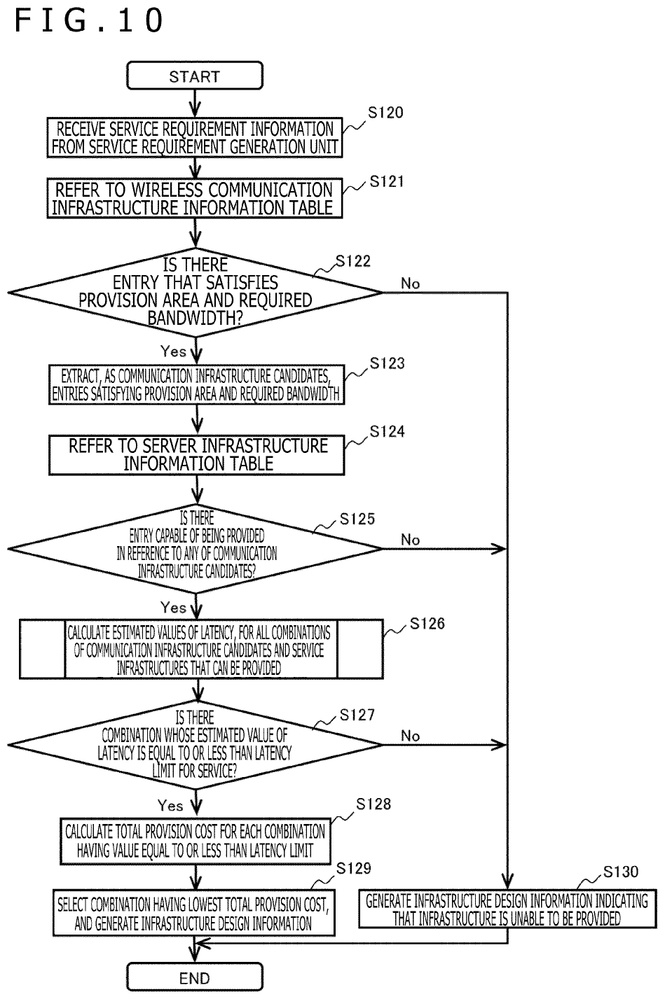

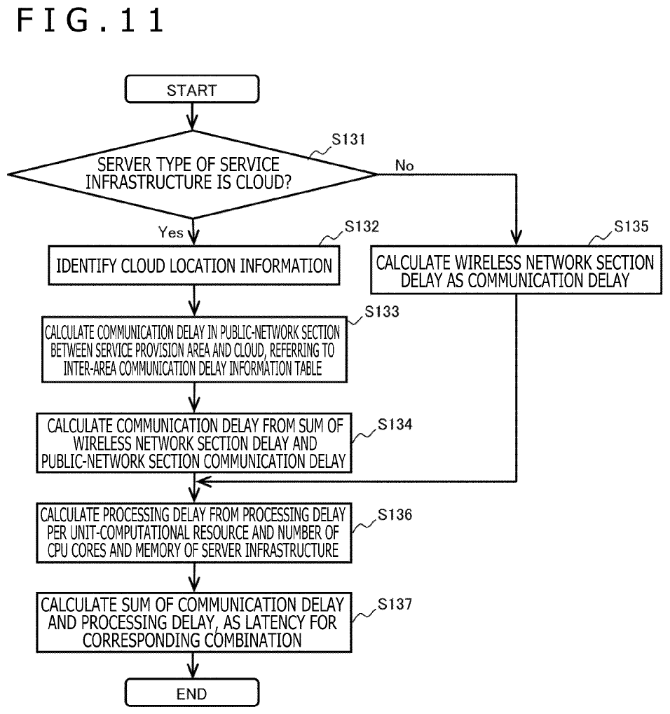

The infrastructure design unit 12 refers to the wireless communication infrastructure information table 200 and the server infrastructure information table 300 on the basis of the received service requirement information, extracts combinations of wireless communication infrastructures and server infrastructures such that the sum of the communication delay and the processing delay is equal to or less than the latency limit for the solution service to be provided, selects, from among the extracted combinations, a combination for which the provision cost is a minimum, and generates infrastructure design information (S105). For example, the infrastructure design information includes a solution service name, the number of service-provided users, a communication infrastructure name of the selected wireless communication infrastructure, a server infrastructure name of the selected server infrastructure, and a total provision cost of the communication infrastructure and the server infrastructure. The details of the processing for generating the infrastructure design information (S105) will be described later by using FIG. 10 and FIG. 11. The infrastructure design unit 12 transmits the generated infrastructure design information to the operator input/output unit 10 (S106). The operator input/output unit 10 generates an output screen on the basis of the received infrastructure design information, and outputs the output screen to the operator 2 (S107).

Next, with reference to the flow chart in FIG. 9, an example of the operation of generating the service requirement information by the service requirement generation unit 11 (S103) will be described in detail. When the service requirement generation unit 11 receives service provision information from the operator input/output unit 10 (S110), the service requirement generation unit 11 first searches the service template table 100 by using, as a search key, a solution service name included in the service provision information, to thereby identify a corresponding entry (S111). Next, the service requirement generation unit 11 calculates requested bandwidth from the number of service-provided users included in the service provision information and the per-unit requested bandwidth 103 of the identified entry. For example, in a case where the per-unit requested bandwidth 103 indicates requested bandwidth for every five users and where the number of users included in the service provision information is 10, the requested bandwidth is two times the per-unit requested bandwidth. Similarly, the service requirement generation unit 11 calculates a processing delay per unit-computational resource from the number of service-provided users included in the service provision information and the per-unit processing delay 104 of the identified entry (S112). Then, the service requirement generation unit 11 generates service requirement information which includes the solution service name, the number of service-provided users, the service provision area, the latency limit included in the identified entry, and the calculated requested bandwidth and processing delay per unit-computational resource (S113).

Next, with reference to the flow chart in FIG. 10, an example of the operation of generating the infrastructure design information by the infrastructure design unit 12 of the infrastructure design server 1 (S105) will be described in detail. When receiving service requirement information from the service requirement generation unit 11 (S120), the infrastructure design unit 12 first refers to the wireless communication infrastructure information table 200 (S121), searches for entries in which the provision area 203 corresponds to a service provision area included in the service requirement information and in which the bandwidth 204 is equal to or greater than requested bandwidth (S122), and extracts, as communication infrastructure candidates, all entries satisfying these conditions (S123). Next, the infrastructure design unit 12 refers to the server infrastructure information table 300 (S124), compares the usable wireless communication infrastructures 304 with the communication infrastructure candidates, and verifies whether there is a combination that can be provided (S125). In a case where there is a combination that can be provided, the infrastructure design unit 12 calculates estimated values of the communication delay and the processing delay for all combinations of the communication infrastructure candidates and server infrastructures that can be provided, and calculates the sum of the estimated values of the communication delay and the processing delay as an estimated value of the latency (S126). Note that a detailed flow chart of this process (S126) will be described later by using FIG. 11. Then, the infrastructure design unit 12 verifies whether there is a combination whose estimated value of the latency is equal to or less than the latency limit for the solution service to be provided (S127), and calculates a total provision cost, which is the sum of the provision costs of the wireless communication infrastructure and the server infrastructure, for each combination of the wireless communication infrastructure and the server infrastructure whose estimated value of latency is equal to or less than the latency limit (S128). Then, the infrastructure design unit 12 selects a combination having the lowest total provision cost, and generates infrastructure design information on the basis of the service requirement information and the entry corresponding to the selected combination in the wireless communication infrastructure information table 200 and the server infrastructure information table 300 (S129). In a case where there is no wireless communication infrastructure satisfying the provision area and the requested bandwidth in S122, where there is no server infrastructure that can be provided in reference to the communication infrastructure candidates in S125, or where there is no combination whose estimated value of latency is equal to or less than the latency limit for the solution service in S127, on the other hand, the infrastructure design unit 12 generates infrastructure design information indicating that the infrastructure is unable to be provided (S130).

Next, with reference to the flow chart in FIG. 11, an example of the operation of calculating an estimated value of latency by the infrastructure design unit 12 of the infrastructure design server 1 for a combination of a communication infrastructure candidate and a server infrastructure (S126) will be described in detail. First, regarding the server infrastructure included in the combination, in a case where the server type 302 of the corresponding entry in the server infrastructure information table 300 is “cloud” (S131), the infrastructure design unit 12 refers to the cloud location information 303 and identifies a location information of the cloud (S132). On the basis of the service provision area included in the service requirement information and the location information of the cloud, the infrastructure design unit 12 refers to the inter-area delay information table 400 to thereby calculate a communication delay in a public-network section between the service provision area and the cloud (S133). Further, the infrastructure design unit 12 acquires the wireless network section delay 205 of the corresponding entry in the wireless communication infrastructure information table 200, calculates the sum of the wireless network section delay 205 and the communication delay in the public-network section, and calculates the communication delay for the combination (S134). In a case where the server type 302 is “edge” in S131, on the other hand, the infrastructure design unit 12 acquires the wireless network section delay 205 of the corresponding entry in the wireless communication infrastructure information table 200, and calculates the wireless network section delay 205 as the communication delay for the combination (S135). Next, the infrastructure design unit 12 calculates a processing delay from the processing delay per unit-computational resource included in the service requirement information, as well as the number of CPU cores 305 and the memory 306, in the server infrastructure information table 300, of the entry corresponding to the server infrastructure included in the combination. For example, in a case where the number of CPU cores and the memory of a unit-computational resource are 32 and 32 GB, respectively, and where the number of CPU cores and the memory of the corresponding entry are 64 and 64 GB, respectively, the processing delay is calculated as half of the processing delay per unit-computational resource (S136). Finally, the infrastructure design unit 12 calculates the sum of the communication delay and the processing delay as an estimated value of the latency for the corresponding combination (S137).

Next, with reference to FIG. 12, an example of a display of a service provision information input screen will be described. FIG. 12 illustrates an example of a display of a service provision information input screen generated by the operator input/output unit 10 of the infrastructure design server 1. The service provision information input screen 700 according to the present embodiment serves as an interface for allowing the operator 2 to select or input a solution service name, the number of users, and a service provision area and execute infrastructure design, for example.

Next, with reference to FIG. 13, an example of a display of an infrastructure design information output screen will be described. FIG. 13 is an explanatory view illustrating an example of a display of an infrastructure design information output screen generated by the operator input/output unit 10 of the infrastructure design server 1. The infrastructure design information output screen 800 according to the present embodiment includes, for example, a solution service name, the number of service-provided users, a communication infrastructure name of the selected wireless communication infrastructure, a server infrastructure name of the selected server infrastructure, and a total provision cost of the communication infrastructure and the server infrastructure.

According to the first embodiment described above, it is possible to provide an infrastructure design system that can promptly and easily generate design information regarding a wireless communication infrastructure and a computational infrastructure, such that a provision cost becomes optimal, while satisfying a latency requirement which includes a communication delay and a processing delay at a time of providing a solution service.

### Second Embodiment

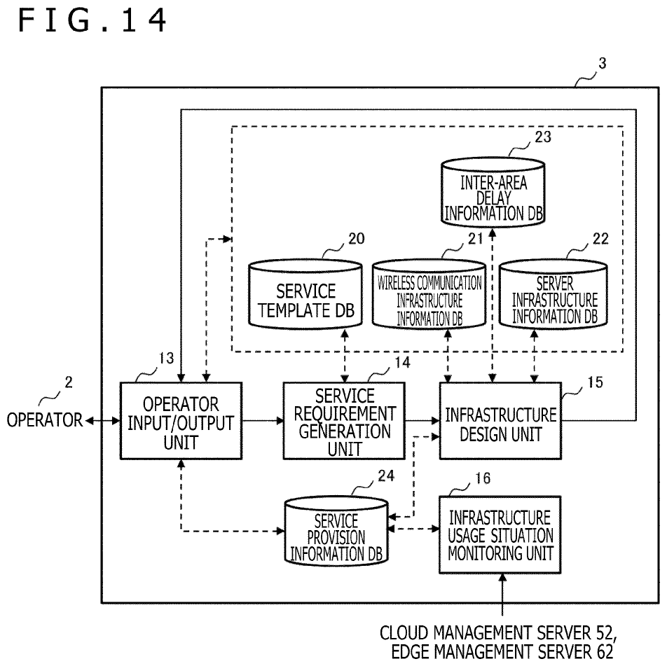

With reference to FIG. 14 through FIG. 20, an infrastructure design system according to a second embodiment will be described below. In the description of the second embodiment, configurations or functions that are the same as those of the first embodiment are denoted by the same reference signs, and description thereof is omitted in some cases. In addition, description similar to that of the first embodiment is omitted in some cases.

The infrastructure design system according to the present embodiment is capable of performing, for a solution service being provided for which infrastructure design has been performed by using this system, the infrastructure design again when the number of service-provided users has changed or the measured latency has exceeded the latency limit for the solution service. Note that, since it requires a large fee to change the wireless communication infrastructure, only the server infrastructure is to be changed when the infrastructure design is performed again.

FIG. 14 is a block view illustrating an example of a functional configuration of an infrastructure design server 3 according to the second embodiment. The infrastructure design server 3 includes an operator input/output unit 13, a service requirement generation unit 14, an infrastructure design unit 15, an infrastructure usage situation monitoring unit 16, the service template DB 20, the wireless communication infrastructure information DB 21, the server infrastructure information DB 22, the inter-area delay information DB 23, and a service provision information DB 24.

In addition to the function of the operator input/output unit 10 according to the first embodiment, the operator input/output unit 13 has a function of, when outputting infrastructure design information generated by the infrastructure design unit 15 to the operator 2, receiving input from the operator 2 as for whether to accept or reject the infrastructure design information, and registering the infrastructure design information in a service provision information table 500 which is managed by the service provision information DB 24, when receiving the input of acceptance, but discarding the infrastructure design information when receiving the input of rejection. The operator input/output unit 13 also has a function of outputting the service provision information table 500 acquired from the service provision information DB 24 to the operator 2, and when the operator 2 selects an entry to be corrected and sends a request to perform a redesign including a change in the number of service-provided users, receiving the request from the operator 2 and outputting service provision information to the service requirement generation unit 14. Further, the operator input/output unit 13 has a function of, when an entry to be redesigned is selected and the latency exceeds the latency limit, receiving a request to perform a redesign and outputting the service provision information to the service requirement generation unit 14.

When receiving the service provision information from the operator input/output unit 13, the service requirement generation unit 14 generates service requirement information by referring to the service template table 100 managed by the service template DB 20, and outputs the service requirement information to the infrastructure design unit 15. The details of the service requirement information for performing the infrastructure design again in the present embodiment will be described later.

When receiving the service requirement information from the service requirement generation unit 14, the infrastructure design unit 15 generates infrastructure design information on the basis of the service requirement information by referring to the wireless communication infrastructure information table 200 managed by the wireless communication infrastructure information DB 21, a server infrastructure information table 600 managed by the server infrastructure information DB 22, the inter-area delay information table 400 managed by the inter-area delay information DB 23, and the service provision information table 500 managed by the service provision information DB 24, and outputs the infrastructure design information to the operator input/output unit 10.

The infrastructure usage situation monitoring unit 16 has a function of connecting to the cloud management server 52 and the edge management server 62, acquiring measurement values of a communication delay and a processing delay in a solution service being provided, calculating an average value of latency in a certain length of time, for example, on the basis of these measurement values, and registering the average value of the latency as measured latency 510 in the service provision information table 500 managed by the service provision information DB 24.

The service provision information DB 24 is a database that manages the service provision information table 500.

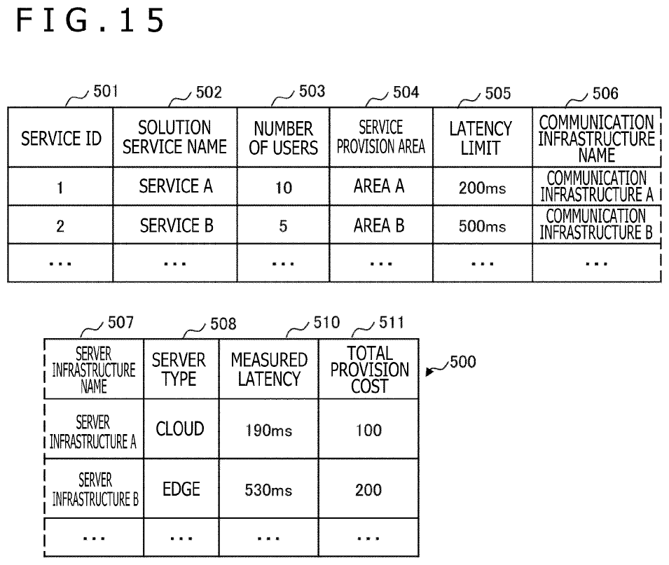

Next, with reference to FIG. 15, an example of a service provision information table will be described. FIG. 15 is an example of the service provision information table 500 managed by the service provision information DB 24 in the second embodiment. The service provision information table 500 includes a service ID 501, a solution service name 502, the number of users 503, a service provision area 504, a latency limit 505, a communication infrastructure name 506, a server infrastructure name 507, a server type 508, the measured latency 510, and a total provision cost 511. The service ID 501 is an ID for uniquely identifying an entry in the service provision information table 500 and is given to an entry which is added when the operator 2 performs infrastructure design to provide a solution service and accepts the generated infrastructure design information. The solution service name 502 is a service name for uniquely specifying a solution service. The number of users 503 and the service provision area 504 are the number of service-provided users and a service provision area which are inputted when the operator 2 executes infrastructure design related to the entry. The latency limit 505 is a latency limit at a time of providing the solution service. The communication infrastructure name 506, the server infrastructure name 507, and the server type 508 are the communication infrastructure name, the server infrastructure name, and the server type that are included in the infrastructure design information generated when infrastructure design corresponding to the entry is executed. The measured latency 510 is a measurement value of latency based on the information regarding the communication delay and the processing delay in each service, which has been acquired by the infrastructure usage situation monitoring unit 16 from the network management server 42, the cloud management server 52, and the edge management server 62. The total provision cost 511 is the total provision cost of the communication infrastructure and the server infrastructure.

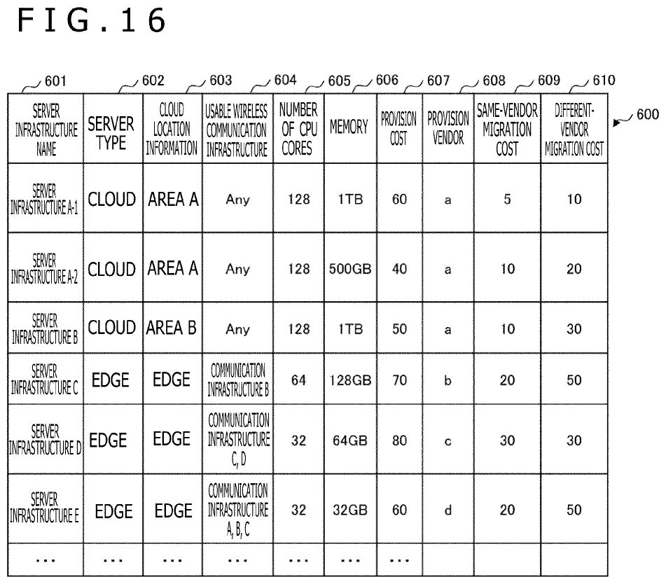

Next, with reference to FIG. 16, an example of a server infrastructure information table will be described. FIG. 16 is an example of the server infrastructure information table 600 managed by the server infrastructure information DB 22 in the second embodiment. Similarly to the server infrastructure information table 300 in the first embodiment, the server infrastructure information table 600 includes a server infrastructure name 601, a server type 602, cloud location information 603, a usable wireless communication infrastructure 604, the number of CPU cores 605, a memory 606, and a provision cost 607, and also includes a provision vendor 608, a same-vendor migration cost 609, and a different-vendor migration cost 610. The provision vendor 608 indicates a vendor for providing a server infrastructure. The same-vendor migration cost 609 is a value used to calculate the cost in a case of migrating between server infrastructures in the same provision vendor. The different-vendor migration cost 610 is a value used to calculate the cost in a case of migrating between server infrastructures in different provision vendors.

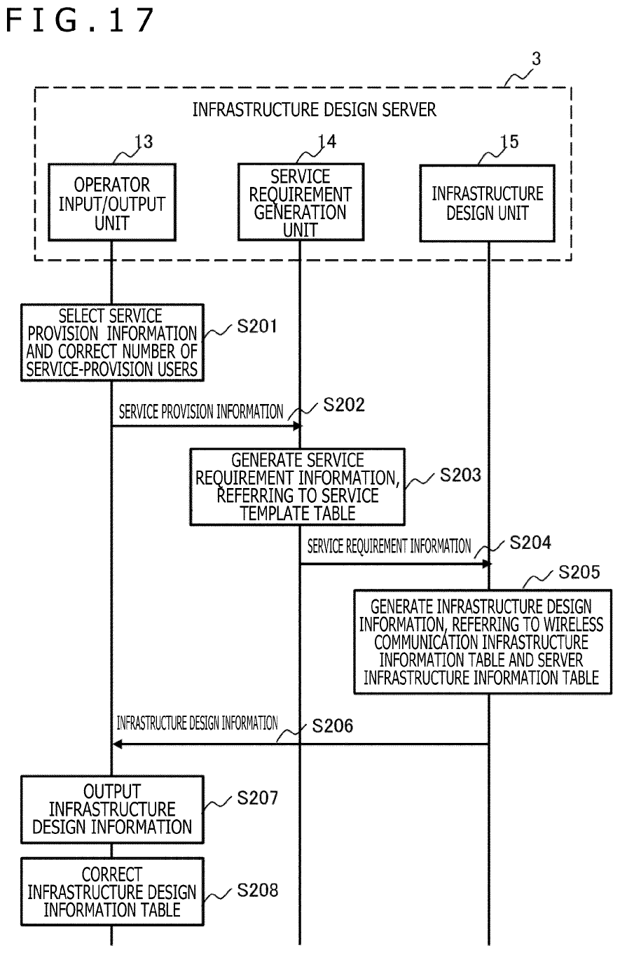

Next, with reference to FIG. 17, an example of an operation performed by the infrastructure design server. FIG. 17 is a sequence diagram illustrating an example of an operation of, by the infrastructure design server 3 according to the present embodiment, correcting the number of service-provided users and performing the infrastructure design again for a solution service being provided.

First, the operator input/output unit 13 displays the service provision information table 500 to the operator 2. When the operator 2 selects an entry to be corrected, the operator input/output unit 13 receives a request to execute a redesign including a change in the number of service-provided users (S201), and outputs service provision information to the service requirement generation unit 14 (S202). The service provision information includes information regarding the service ID of the entry selected by the operator 2 in the service provision information table 500, the solution service name, the changed number of service-provided users, and the service provision area. Similarly to S103, the service requirement generation unit 14 refers to the service template table 100 on the basis of the service provision information received from the operator input/output unit 13, generates service requirement information (S203), and outputs the service requirement information to the infrastructure design unit 15 (S204). The service requirement information includes the service ID of the entry selected by the operator 2 in the service provision information table 500, the solution service name, the changed number of service-provided users, the service provision area, the latency limit included in the identified entry, the calculated requested bandwidth, and the processing delay per unit-computational resource.

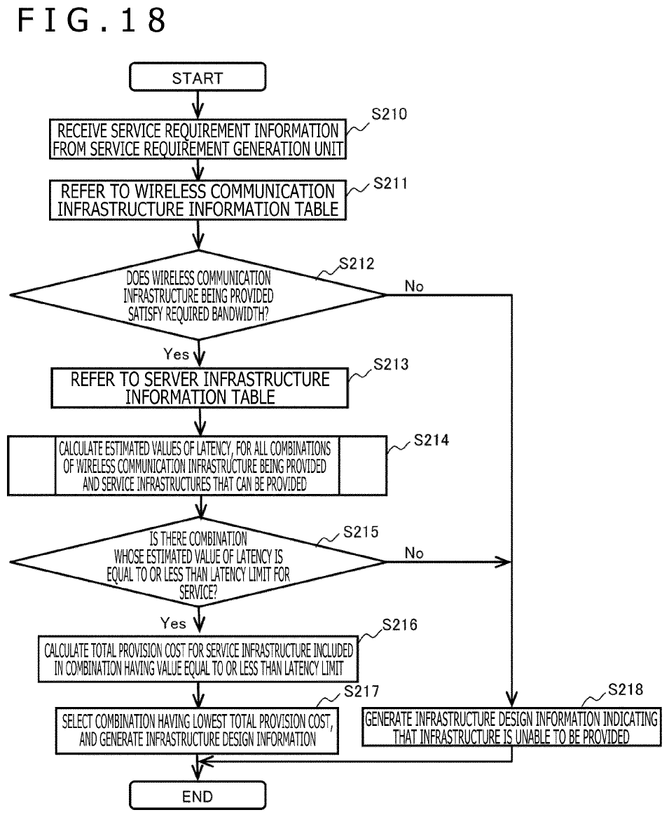

The infrastructure design unit 15 refers to the wireless communication infrastructure information table 200 and the server infrastructure information table 600 on the basis of the received service requirement information, extracts combinations of server infrastructures and the wireless communication infrastructure used by the solution service being provided, such that the sum of the communication delay and the processing delay is equal to or less than the latency limit for a solution service to be provided, selects, from among the extracted combinations, a combination having the lowest total cost, which is the sum of the provision cost and the migration cost, and generates infrastructure design information (S205). For example, the infrastructure design information includes the solution service name, the number of service-provided users, the communication infrastructure name of the wireless communication infrastructure, the server infrastructure name of the selected server infrastructure, and the total provision cost of the communication infrastructure and the server infrastructure. The details of the processing for generating the infrastructure design information (S205) will be described later by using FIG. 18. The infrastructure design unit 15 then transmits the generated infrastructure design information to the operator input/output unit 13 (S206). The operator input/output unit 13 generates an output screen on the basis of the received infrastructure design information, and outputs the output screen to the operator 2 (S207). Further, in a case where the operator 2 has made input to accept the infrastructure design information, the operator input/output unit 13 corrects a corresponding entry in the infrastructure design information table (service provision information table 500) according to the infrastructure information (S208).

Next, with reference to the flow chart in FIG. 18, an example of the operation of generating the infrastructure design information by the infrastructure design unit 15 of the infrastructure design server 3 (S205) will be described in detail. First, when the infrastructure design unit 15 receives service requirement information from the service requirement generation unit 14 (S210), the infrastructure design unit 15 refers to the wireless communication infrastructure information table 200 (S211), and verifies whether the wireless communication infrastructure being provided satisfies the requested bandwidth (S212). In a case where the requested bandwidth is satisfied, the infrastructure design unit 15 refers to the server infrastructure information table 600 (S213), calculates estimated values of the communication delay and the processing delay for all combinations of the communication infrastructure being provided and server infrastructure that can be provided, and calculates the sum of the estimated values of the communication delay and the processing delay as an estimated value of latency (S214). This processing (S214) is similar to the processing described by using FIG. 11 in the first embodiment. Then, the infrastructure design unit 15 verifies whether there is a combination whose estimated value of latency is equal to or less than the latency limit for the solution service to be provided (S215), and calculates the total cost, which is the sum of the provision cost and the migration cost, for the server infrastructure included in the combination whose estimated value of latency is equal to or less than the latency limit (S216). To calculate the total cost, the provision vendors 608 of a corresponding server infrastructure and the server infrastructure being provided are compared with each other, and when they are the same, the same-vendor migration cost 609 is used as the migration cost. When they are different from each other, on the other hand, the different-vendor migration cost 610 is used as the migration cost. As a result, the cost required to migrate between server infrastructures provided by the same provision vendor can be estimated to be lower. Then, the infrastructure design unit 15 selects a combination having the lowest provision cost and generates infrastructure design information on the basis of the service requirement information and the entry corresponding to the selected combination in the wireless communication infrastructure information table 200 and the server infrastructure information table 300 (S217). In a case where the wireless communication infrastructure being provided does not satisfy the requested bandwidth in S212 or where there is no combination whose estimated value of latency is equal to or less than the latency limit for the solution service in S215, on the other hand, the infrastructure design unit 15 generates infrastructure design information indicating that the infrastructure is unable to be provided (S218).

As described above, even if the number of users using the solution service being provided increases or decreases and requirements for the requested bandwidth and the latency limit are thus changed, it is possible to deal with such a change and promptly and easily execute a redesign of a server infrastructure such that the cost is optimal.

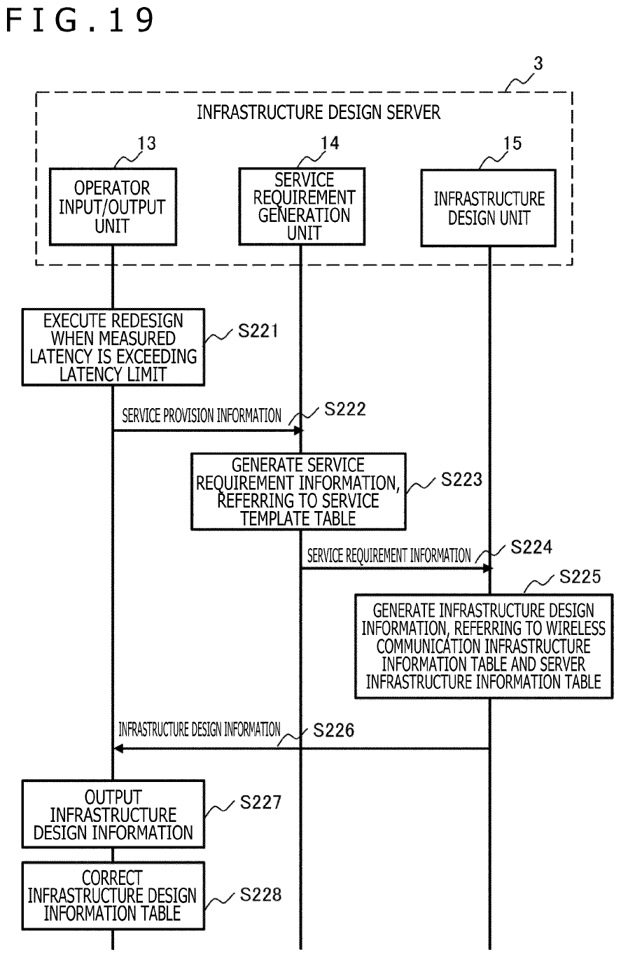

Next, with reference to FIG. 19, an example of an operation performed in a case where the measured latency is exceeding a latency limit will be described. FIG. 19 is a sequence diagram illustrating an example of an operation of performing the infrastructure design again by the infrastructure design server 3 according to the present embodiment for a solution service being provided, in a case where the measured latency is exceeding a latency limit. First, the operator input/output unit 13 displays the service provision information table 500 to the operator 2. When the operator 2 selects an entry to be redesigned and sends a request to execute a redesign due to the latency exceeding the latency limit, the operator input/output unit 13 receives the request (S221) and outputs service provision information to the service requirement generation unit 14 (S222). The service provision information includes the service ID of the entry selected by the operator 2 in the service provision information table 500, the solution service name, the service provision area, and a latency limit exceeded flag indicating that a redesign is required due to the latency exceeding the latency limit. Similarly to S103, the service requirement generation unit 14 refers to the service template table 100 on the basis of the service provision information received from the operator input/output unit 13, generates service requirement information (S223), and outputs the service requirement information to the infrastructure design unit 15 (S224). The service requirement information includes the service ID of the entry selected by the operator 2 in the service provision information table 500, the solution service name, the service provision area, the latency limit included in the identified entry, the calculated requested bandwidth, the processing delay per unit-computational resource, and the latency limit exceeded flag.

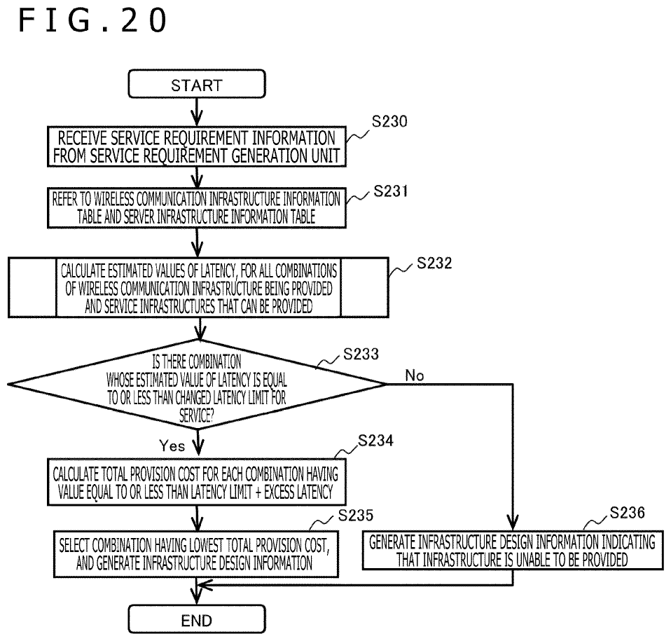

The infrastructure design unit 15 refers to the service provision information table 500 on the basis of the received service requirement information, calculates, as a changed latency limit, a value obtained by subtracting an excess of the measured latency 510 with respect to the latency limit 505 from the latency limit 505, refers to the wireless communication infrastructure information table 200 and the server infrastructure information table 600, extracts combinations of server infrastructures and the wireless communication infrastructure used by the solution service being provided, such that the sum of the communication delay and the processing delay is equal to or less than the changed latency limit, selects, from among the extracted combinations, a combination having the lowest total cost, which is the sum of the provision cost and the migration cost, and generates infrastructure design information (S225). For example, the infrastructure design information includes the solution service name, the number of service-provided users, the communication infrastructure name of the wireless communication infrastructure, the server infrastructure name of the selected server infrastructure, and the total provision cost of the communication infrastructure and the server infrastructure. The details of the processing for generating the infrastructure design information (S225) will be described later by using FIG. 20. The infrastructure design unit 15 then transmits the generated infrastructure design information to the operator input/output unit 13 (S226). The operator input/output unit 13 generates an output screen on the basis of the received infrastructure design information and outputs the output screen to the operator 2 (S227). Further, in a case where the operator 2 has made input to accept the infrastructure design information, the operator input/output unit 13 corrects a corresponding entry in the infrastructure design information table (service provision information table 500) according to the infrastructure information (S228).

Next, with reference to the flow chart in FIG. 20, an example of the operation of generating the infrastructure design information by the infrastructure design unit 15 of the infrastructure design server 3 (S225) will be described in detail. First, when the infrastructure design unit 15 receives service requirement information from the service requirement generation unit 14 (S230), the infrastructure design unit 15 refers to the wireless communication infrastructure information table 200 and the server infrastructure information table 600 (S231), calculates estimated values of the communication delay and the processing delay for all combinations of the communication infrastructure being provided and server infrastructures that can be provided, and calculates the sum of the estimated values of the communication delay and the processing delay as an estimated value of latency (S232). This processing (S232) is similar to the processing described by using FIG. 11 in the first embodiment. Then, the infrastructure design unit 15 verifies whether there is a combination whose estimated value of latency is equal to or less than the changed latency limit for the solution service to be provided (S233), and calculates the total cost, which is the sum of the provision cost and the migration cost, for the server infrastructure included in the combination whose estimated value of latency is equal to or less than the latency limit (S234). To calculate the total cost, the provision vendors 608 of a corresponding server infrastructure and the server infrastructure being provided are compared with each other, and when they are the same, the same-vendor migration cost 609 is used as the migration cost. When they are different from each other, on the other hand, the different-vendor migration cost 610 is used as the migration cost. Then, the infrastructure design unit 15 selects a combination having the lowest provision cost and generates infrastructure design information on the basis of the service requirement information and the entry corresponding to the selected combination in the wireless communication infrastructure information table 200 and the server infrastructure information table 600 (S235). In a case where there is no combination whose estimated value of latency is equal to or less than the latency limit for the solution service in S233, on the other hand, the infrastructure design unit 15 generates infrastructure design information indicating that the infrastructure is unable to be provided (S236).

As described above, even in a case where the latency exceeds a latency limit in the solution service being provided, the excess can be eliminated by reducing the processing delay, and a redesign of a server infrastructure can promptly and easily be executed such that the cost is optimal.

Note that the present invention is not limited to the embodiments described above and includes various modifications and configurations equivalent to those described above within the spirit of the attached claims. For example, the embodiments have been described above in detail in order to facilitate understanding of the present invention, but the present invention is not necessarily limited to one including all configurations described above. Further, part of the configuration of one embodiment may be replaced by the configuration of another embodiment. In addition, the configuration of one embodiment may be added to the configuration of another embodiment. Moreover, addition of another configuration, deletion, and replacement may be made on part of the configuration of each embodiment.

For example, even in a case where the server infrastructure 50 is located in a remote location such as a foreign country and there is a great distance to the place where the service is used, a proper evaluation can be carried out through the processing by taking into account the physical distance between the server infrastructure and the solution service usage environment 70.

In the embodiments described above, the infrastructure design server has been described as an example of an infrastructure design apparatus which is a computer for performing infrastructure design. However, it is sufficient if appropriate processing can be performed, and the infrastructure design apparatus may be a computer that does not provide data or the like to another computer, for example.

What is claimed is:

1. An infrastructure design system comprising:
an infrastructure design apparatus configured to generate infrastructure design information including information regarding a server infrastructure in which an application of a solution service is installed and a wireless communication infrastructure that connects the server infrastructure with a place where the solution service is used, wherein
the infrastructure design apparatus includes
a processor and a storage unit,
the storage unit manages provision cost information regarding each of the wireless communication infrastructure and the server infrastructure, and
the processor
calculates estimated latency at a time of providing the solution service, on a basis of a communication delay between the place where the solution service is used and the server infrastructure and a processing delay of the application, and
selects a combination of the wireless communication infrastructure and the server infrastructure on a basis of the estimated latency and a provision cost managed by the storage unit, and outputs the combination as infrastructure design information.

2. The infrastructure design system according to claim 1, wherein
the storage unit manages, for each wireless communication infrastructure, information regarding a communication delay in a section of the wireless communication infrastructure,
the storage unit manages location information regarding each server infrastructure, and
the processor
estimates a communication delay at a time of providing the solution service, for the combination of the wireless communication infrastructure and the server infrastructure, on a basis of the information regarding the communication delay in the section of the wireless communication infrastructure, a location of the place where the solution service is used, and the location information regarding the server infrastructure.

3. The infrastructure design system according to claim 1, wherein
the storage unit manages computational resource information regarding each server infrastructure,
the storage unit manages processing delay information regarding a processing delay of the application per unit-computational resource and the number of unit users of each solution service, and
the processor
estimates a processing delay at a time of providing the solution service, on a basis of the computational resource information regarding each server infrastructure, the processing delay information regarding the processing delay of the application per unit-computational resource and the number of unit users of each solution service, and the number of users who use the solution service.

4. The infrastructure design system according to claim 1, wherein
the processor
selects a combination of the wireless communication infrastructure and the server infrastructure such that the estimated latency is equal to or less than latency required by the solution service and a provision cost is a minimum, and outputs the combination as the infrastructure design information.

5. The infrastructure design system according to claim 1, wherein
the storage unit manages, as the provision cost information, a monetary cost for provision of the wireless communication infrastructure and the server infrastructure.

6. The infrastructure design system according to claim 1, wherein
the storage unit manages, as the provision cost information, an amount of carbon dioxide emitted upon provision of the wireless communication infrastructure and the server infrastructure.

7. The infrastructure design system according to claim 1, wherein
the processor
calculates the estimated latency for a combination of a wireless communication infrastructure being provided and the server infrastructure capable of being combined with the wireless communication infrastructure being provided, when the number of users who use a solution service being provided in the infrastructure design information has changed, and
selects the server infrastructure on a basis of the estimated latency, the provision cost, and a migration cost, and outputs the server infrastructure as the infrastructure design information.

8. The infrastructure design system according to claim 1, wherein
the processor
calculates the estimated latency for a combination of a wireless communication infrastructure being provided and the server infrastructure capable of being combined with the wireless communication infrastructure being provided, in a case where a measurement value of latency in a solution service being provided in the infrastructure design information has exceeded latency required by the solution service, and
selects the server infrastructure on a basis of the estimated latency, the provision cost, and a migration cost, and outputs the server infrastructure as the infrastructure design information.

9. An infrastructure design system comprising:
an infrastructure design server configured to generate infrastructure design information including information regarding a server infrastructure in which an application of a solution service is installed and a wireless communication infrastructure that connects the server infrastructure with a place where the solution service is used; and
a terminal of the infrastructure design server, wherein
the infrastructure design server includes
a processor, a storage unit, and a communication interface,
the storage unit manages provision cost information regarding each of the wireless communication infrastructure and the server infrastructure, and
the processor
calculates estimated latency at a time of providing the solution service, on a basis of a communication delay between the place where the solution service is used and the server infrastructure and a processing delay of the application, and
selects a combination of the wireless communication infrastructure and the server infrastructure on a basis of the estimated latency and a provision cost managed by the storage unit, and outputs the combination as infrastructure design information to the terminal via the communication interface.

10. An infrastructure design method of generating, by an infrastructure design apparatus including a processor and a storage unit, infrastructure design information including information regarding a server infrastructure in which an application of a solution service is installed and a wireless communication infrastructure that connects the server infrastructure with a place where the solution service is used, the method comprising:
managing, by the storage unit, provision cost information regarding each of the wireless communication infrastructure and the server infrastructure;
calculating, by the processor, estimated latency at a time of providing the solution service, on a basis of a communication delay between the place where the solution service is used and the server infrastructure and a processing delay of the application; and
selecting, by the processor, a combination of the wireless communication infrastructure and the server infrastructure on a basis of the estimated latency and a provision cost, and outputting the combination as infrastructure design information.
